(19) United States
(12) Patent Application Publication
(10) Pub. No.: US 2024/0112124 A1
(43) Pub. Date: Apr. 4, 2024

(54) SMART SKILLS VERIFICATION SYSTEM

(71) Applicant: ADP, Inc., Roseland, NJ (US)

(72) Inventor: Jyotsna Manikantan, Edison, NJ (US)

(21) Appl. No.: 17/936,749

(22) Filed: Sep. 29, 2022

(51) Int. Cl. G06Q 10/06; G06F 40/40

(52) U.S. Cl. CPC G06Q 10/06398; G06F 40/40

(57) ABSTRACT

Disclosed are various embodiments for identifying skills acquired by a user and verifying a level of competency for the acquired skills. In one non-limiting example, a system comprises a computing device that is configured to identify characteristics associated with a project assigned to a user identifier and determine a time period for soliciting a user review for the user identifier. A user interface prompt is transmitted to a corresponding client device associated with another user assigned to the project. Skills data is extracted from a prompt response received from the corresponding client device. A search index database is generated and configured to identify a respective user profile. The skills data is stored in association with the user identifier in the search index database.

### BACKGROUND

Companies encourage their employees to constantly improve their skill set. As employees learn new skills, these employees often become more valuable to the company. Employees can obtain training in various forms and from numerous educational or vocational providers. For example, employees can receive training from traditional universities, community colleges, online education providers, certification programs, and other suitable education providers. In addition, employees can acquire on-job skills that are specifically relevant to their company's business.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1A-1C illustrate example user interfaces for client devices, according to various embodiments of the present disclosure.

FIG. 2 is a drawing of a networked environment according to various embodiments of the present disclosure.

FIG. 3 is a sequence diagram for the networked environment of FIG. 2, according to various embodiments of the present disclosure.

FIGS. 4A and 4B illustrate example user interfaces for performing a search query and viewing search results, according to various embodiments of the present disclosure.

FIGS. 5A and 5B are flowcharts illustrating one example of functionality implemented as portions of a verification service executed in a computing environment in the networked environment of FIG. 2 according to various embodiments of the present disclosure.

### DETAILED DESCRIPTION

The present disclosure relates to identifying new skills developed by a user (e.g., an employee of a company) over time and verifying a level of a competency for the newly acquired skills. Businesses today employ people who enter or begin their employment with an initial set of skills. Oftentimes, employees are continuously learning new skills on the job and stretching to learn skills in a new field in their personal time.

In many cases, employers have human resource systems that fail to track the skill development of their employees over time. For example, multiple human resource (HR) systems may be disconnected from each other. In this context, a first HR system may have a listing of training courses completed by an employee for reimbursement processing. Meanwhile, a second HR system used by hiring managers could keep a list of qualifications an employee had when they joined the company. However, the second HR systems may be disconnected from the first HR system, resulting in the second HR system slowly becoming out of date as an employee acquires new skills or certifications.

In addition, employee performance evaluation and reward processes may fail to accurately track and reward employees because these processes can rely on an employee's manager's perceived notion of the employee's contributions. However, the manager may have a limited view of the new skills acquired by the employee over a period of time or an employee's contributions to the company. For example, the employee may be assigned to work on various projects in a multi-faceted business organization, and the employee's manager may be unaware or not fully aware of the employee's role in projects outside the manager's purview. As another example, the employee's manager could change several times over a period of time.

The various embodiments of the present disclosure also relate to automated systems and methods for continuously identifying employee skills from various sources, analyzing structured and unstructured employee feedback, and aggregating in a real-time (or substantially real-time) manner these data elements in a search index database. Certain embodiments may be capable of achieving certain advantages and improvements over prior designs, including some or all of the following: (1) improving human resource systems by automatically updating employee profiles with new skills acquired by the employees from various sources; (2) updating a search index database of employee skills in a substantially real-time or real time manner; (3) assessing employees skills with feedback in structured and unstructured forms in an automated manner from various users; and (4) modifying settings of client devices and/or applications executed on client devices to report data related to acquired skills of an employee. In the following discussion, a general description of the system and its components is provided, followed by a discussion of the operation of the same.

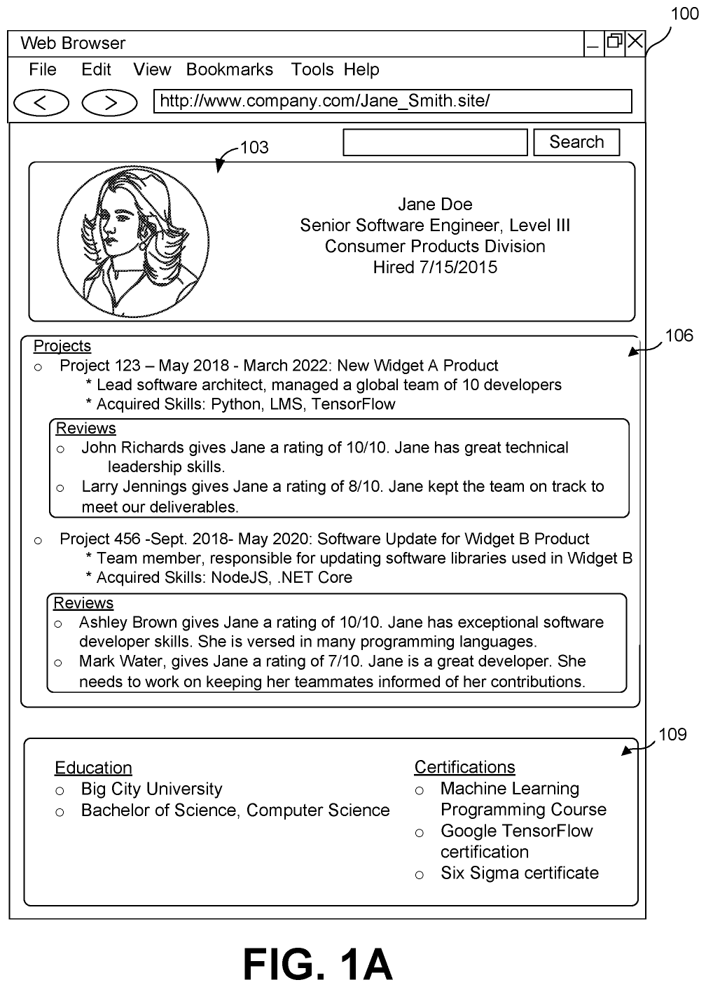

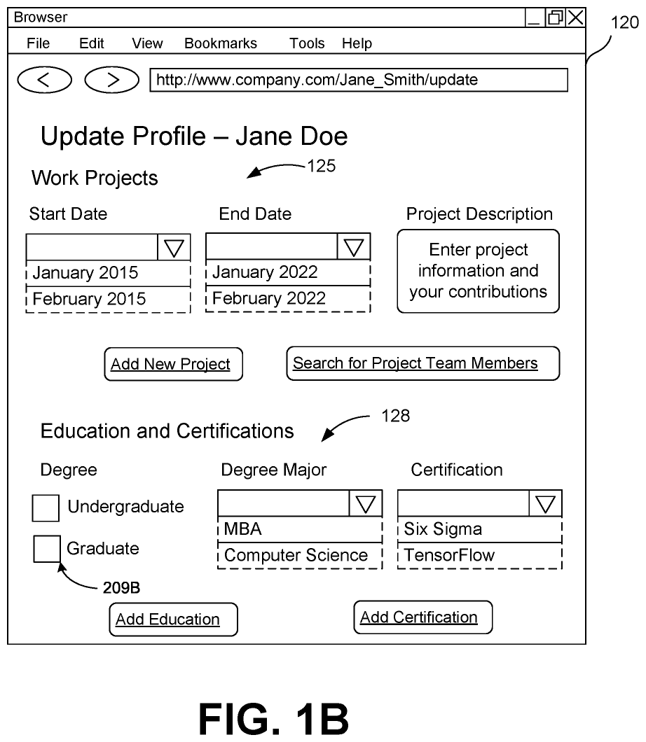

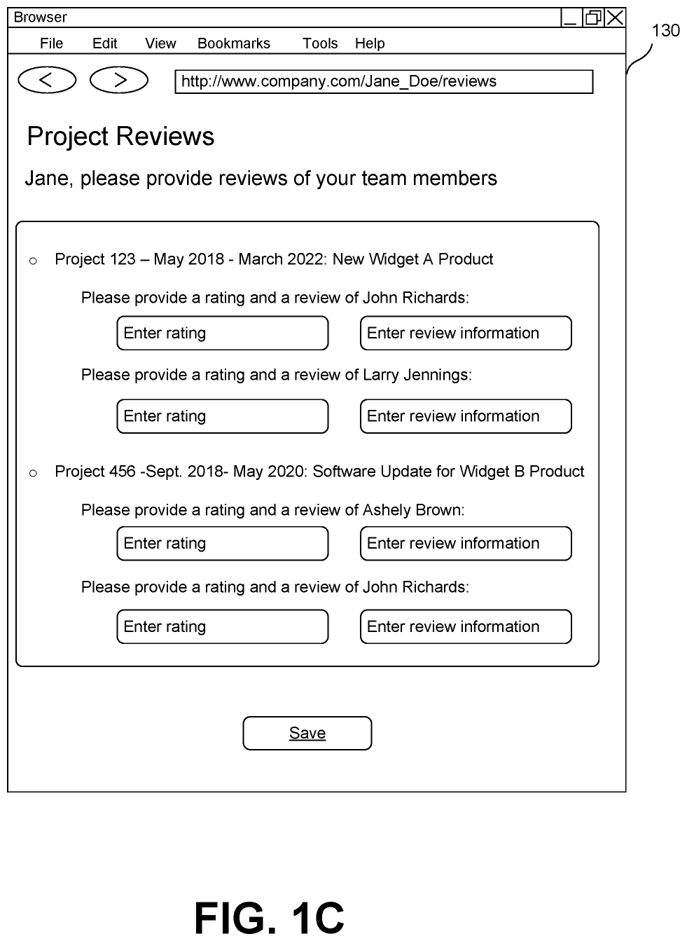

FIG. 1A is an example of a management user interface 100 for viewing employee profiles. Presently, the management user interface 100 illustrates a user profile for a user, illustrated as the user “Jane Doe.” The management user interface 100 can represent a full version of attributes or data a company has for a user (e.g., an employee). In contrast, the user (e.g., Jane Doe) represented by the user profile or another user may be able to view a restricted version of the data that is shown.

The management user interface 100 displays a profile section 103, a project section 106, a credential section 109, and other suitable elements. The profile section 103 can include a picture of the user (e.g., Jane Doe), the user's name, a user identifier, title or position, hiring date, and/or other suitable profile data.

The project section 106 can represent an aggregation of work projects the user has participated in while working for the company, skills the user has developed over time, reviews received from other employees (e.g., managers and peers), and other suitable data. The reviews can represent underlying data that facilitates determining a level of competency for particular skills. The project section 106 can display skills data that has been received from various sources. In the illustrated example, the skills data is organized around work projects. The skills data can be organized in other manners.

Each work project can represent a task or responsibility to be completed and the task is assigned to one or more employees. In the illustrated example, the work projects include a title, a start date, an end date, a project description, the user's role in the project, skills used or acquired by the user, and other suitable data. In some embodiments, the work project information can be provided by the user. For example, the user (e.g., Jane Doe) may enter in a profile user interface (e.g., see FIG. 1B) skills that she acquired or used during this project. In other scenarios, the work project information can be collected from various data sources (e.g., project data which may include project objectives and key project results, employee emails, management systems, calendar meetings, chat conversations, etc.). Additionally, feedback data (e.g., testimonials, ratings, etc.) about the user's work product is received and displayed. The feedback data can represent structured and/or unstructured feedback that is received from other users (e.g., peers, the user's subordinates, the user's manager, etc.). The feedback data can be solicited at various times (e.g., during the course of the project or after the completion of the project). In an employee view of the user interface (e.g., Jane Doe's view), the names of the reviewers can be omitted, and she can only see the substance of individual reviews. As such, the anonymous nature of the review process can encourage candid and constructive feedback from the other users.

The credential section 109 can represent a section for displaying education degrees, certifications, licenses, and other formal training completed by the user. Over time, the employee's credential section 109 can be updated automatically based at least in part on input from external sources (e.g., university system, online training systems, etc.) and/or from input from the user.

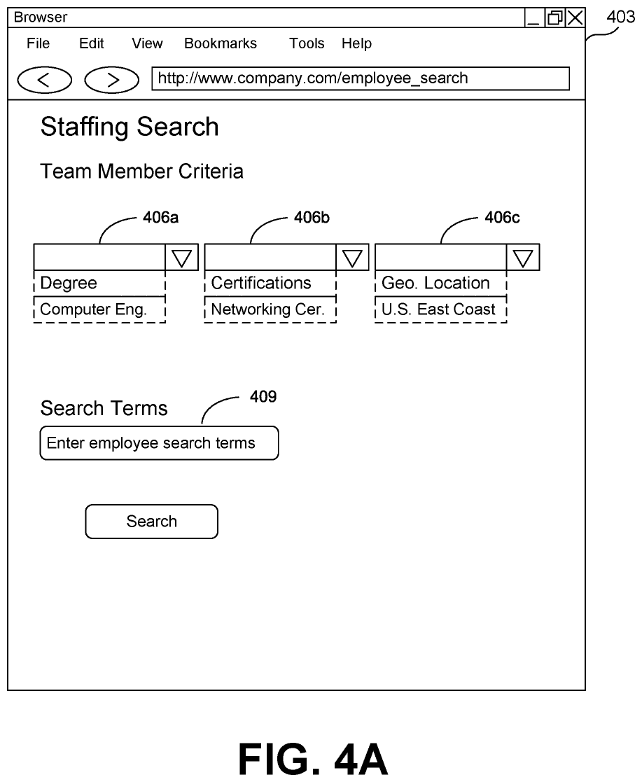

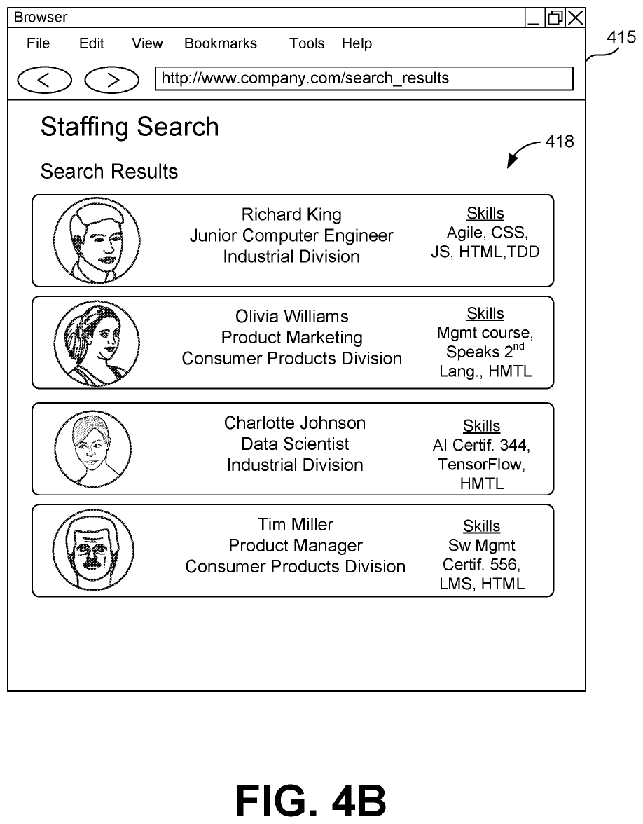

The management user interface 100 can be useful for the user's manager to see the development of the user over time based at least in part on data collected from various data sources. The user's manager can use this data for performance reviews, for compensation evaluations, for staffing decisions, and other suitable occasions. For example, the management user interface 100 can be used by hiring project managers that need to add personnel to a project with certain skills. These managers can execute a search using a company database (FIG. 4A) and the company database can provide search results with multiple user profiles (FIG. 4B) that match the search criteria. After a selection of a particular user profile (e.g., Jane Doe's user profile), the manager can view the management user interface 100 for Jane Doe's user profile.

Next, FIG. 1B is an example of a profile user interface 120 for the user to enter information into his or her user profile. The information entered can be stored in the user profile. In this illustrative example, the user (e.g., Jane Doe) can enter work project information 125 and credential information 128. For example, the user can enter work project data, such as a start date, end date, a project description, project team members, and/or other suitable elements. After the work project information has been entered, the user can select a button for uploading the work project data. In some embodiments, the project team members can be automatically identified based at least in part on interaction data associated with the user and other suitable data.

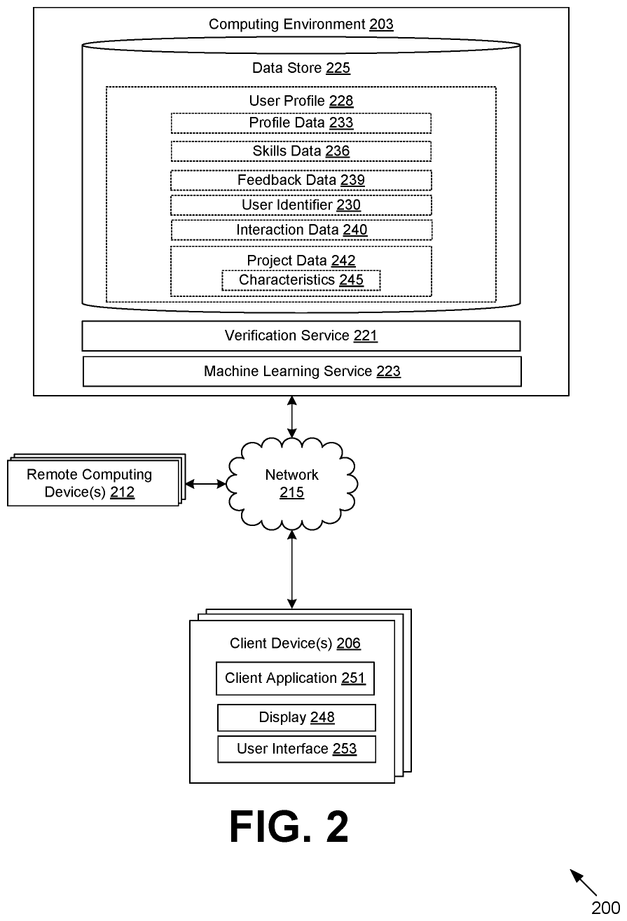

Additionally, the profile user interface 120 can be used by the user to enter education information (e.g., type of degree, degree major, name of university, honors credentials). Further, the profile user interface 120 can be used to enter certification information (e.g., licenses, certification, etc.). The education information and the certification information can be verified after being entered. The system can connect to an education or learning provider system (e.g., remote computing device in FIG. 2) to compare the education and credential information provided by the user to the data stored in these systems.

Further, FIG. 1C is an example of a review user interface 130 for providing feedback data on one or more users. The review user interface 130 can be sent to the user during the course of a project, after the completion of a project, after a completion of a project milestone, and at other suitable periods of time. The timing for sending the review user interface 130 can be determined based at least in part on various factors. The feedback is provided anonymously to the user being reviewed.

For example, the review user interface 130 has identified two projects (e.g., Project 123 and Project 456) associated with the user. In each of these projects, the review user interface 130 includes multiple project users that were also assigned. The user can enter feedback data (e.g., a rating or a testimonial) associated with each project user.

With reference to FIG. 2, shown is a networked environment 200 according to various embodiments. The networked environment 200 includes a computing environment 203, one or more client devices 206, and a remote computing device 212, which are in data communication with each other via a network 215. The network 215 includes, for example, the Internet, intranets, extranets, wide area networks (WANs), local area networks (LANs), wired networks, wireless networks, or other suitable networks, etc., or any combination of two or more such networks. For example, such networks may comprise satellite networks, cable networks, Ethernet networks, and other types of networks.

The computing environment 203 may include, for example, a server computer or any other system providing computing capability. Alternatively, the computing environment 203 may employ a plurality of computing devices that may be arranged, for example, in one or more server banks or computer banks or other arrangements. Such computing devices may be located in a single installation or may be distributed among many different geographical locations. For example, the computing environment 203 may include a plurality of computing devices that together may comprise a hosted computing resource, a grid computing resource and/or any other distributed computing arrangement. In some cases, the computing environment 203 may correspond to an elastic computing resource where the allotted capacity of processing, network, storage, or other computing-related resources may vary over time.

Various applications and/or other functionality may be executed in the computing environment 203 according to various embodiments. The components executed on the computing environment 203, for example, may include a verification service 221, a machine learning service 223, and other applications, services, processes, systems, engines, or functionality not discussed in detail herein. The verification service 221 is executed to track and verify the skills a user has developed over time. The machine learning service 223 can represent one or more computing devices that are used for training, deploying, and evaluating machine learning models. The machine learning models can be used to implement natural language processing functionality, such as sentiment analysis, an email classification, chat services, question-and-answer services, and other suitable natural language processing functionality. In some embodiments, the machine learning models may implement a convolutional neutral networks (CNN), recurrent neural network (RNN), and other suitable machine learning approaches.

Also, various data is stored in a data store 225 that is accessible to the computing environment 203. The data store 225 may be representative of a plurality of data stores 225 as can be appreciated. The data stored in the data store 225, for example, is associated with the operation of the various applications and/or functional entities described below. In some embodiments, the data store 225 can also represent a search index database for identifying user profiles based at least in part on a search query. For example, the search query can include items (e.g., search criteria) for identifying a user profile stored in the data store 225. The search index data can include an index that associates the user profile with the data associated with the user profile. The data stored in the data store 225 includes, for example, user profiles 228, and potentially other data. The user profile 228 can represent a user account for a user at a company. In some examples, the user profile 228 can represent a human resources or a manager's data for a user. The user profile 228 can include a user identifier 230, profile data 233, skills data 236, feedback data 239, interaction data 240, project data 242, achievement data (e.g., awards and recognitions), and other suitable data.

The user identifier 230 can represent a unique identifier for each user profile 228. In some examples, the user identifier 230 can be an alphanumeric character string, a data signature, a device signature, or other suitable identifiers. In some embodiments, the data signature can include a set of unique data for the user (e.g., hire data, social security number, employee number or identifier, residence location, etc.). The device signature for a user can include one or more of an internet protocol (IP) address, a device identifier of a client device 206, a device type, an operating system version, a set of installed applications, and other suitable unique data for a user.

The profile data 233 can represent background information, such as the user's name, title, hiring date, company department, and other suitable information. The skills data 236 can represent information related to various skill sets that the user has developed over the course of the user's employment. In some examples, skills information is entered by the user. In other instances, the skills can be extracted from reviews by other company users and extracted from data provided by third party entities (e.g., remote computing device 212 shown in FIG. 2).

The feedback data 239 can be representative of review data that is provided by project users (e.g., peers, managers, subordinates, etc.) for a project. The feedback data 239 can be structured (e.g., a numerical rating scale, selecting a rating option) or unstructured (e.g., freeform text).

The interaction data 240 can be representative of data associated the client device 206 collected over a period of time. The data can be related to various interactions occurring, being performed, or observed by the client device 206. Some non-limiting examples of interaction data 240 can include email data, calendar meetings, chat messaging data, video communication platforms data (e.g., Microsoft Teams, Webex, Zoom, etc.), a virtual meeting assistant (e.g., Webex Assistant) that records meeting notes or generates a transcript of the meetings, meeting transcripts, and other suitable data.

The project data 242 can represent information associated with one or more projects associated with the user profile 228. The one or more projects can be a list of currently active projects or a history of all projects associated with the user while employed by the company. The project data 242 can include characteristics 245 associated with each of the projects. Some non-limiting examples of characteristics 245 include a project start date, a project end date, project users (e.g., teammates/peers, managers, subordinates), user's position or title, a project description, project hierarchy classification, and other suitable data.

The client device 206 is representative of one or more client devices 206 that may be coupled to the network 215. The client device 206 may be representative of a client device used by the user and/or a corresponding client devices used by project users. The client device 206 can include any computer system. Examples of computer systems can include a desktop computer, a laptop computer, personal digital assistants, cellular telephones, smartphones, set-top boxes, music players, web pads, tablet computer systems, game consoles, electronic book readers, or other devices with like capability. The client device 206 may include a display 248. The display 248 may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client device 206 may be configured to execute various applications such as a client application 251 and/or other applications. The client application 251 is executed to facilitate identifying data for storage in the user profile 228 (e.g., skills data 236 and feedback data 239). The client application 251 can communicate with the verification service 221 for transferring data and coordinating review prompts and other user interface displays. Additionally, the client application 251 may be executed in a client device 206, for example, to access network content served up by the computing environment 203 and/or other servers, thereby rendering a user interface 253 on the display 248. To this end, the client application 251 may comprise, for example, a browser, a dedicated application, etc., and the user interface may comprise a network page, an application screen, etc. The client device 206 may be configured to execute applications beyond the client application 251 such as, for example, email applications, social networking applications, word processors, spreadsheets, and/or other applications. Additionally, the client application 251 can be executed to record interaction data 240 (e.g., interaction events) occurring on the client device 206. The client application 251 can also be configured to modify the settings of one or more installed applications to record interaction data 240.

The remote computing device 212 can be representative of one or more computing devices for third party entities that interact with the computing environment 203 or the client device 206. Some examples of third-party entities can include education or training providers, social media providers, licensing providers, and other suitable third-party entities. The remote computing device 212 can provide data for the client device 206 and/or the computing environment 203 for identifying skills data 236 (e.g., users achievements), profile data 233 (e.g., promotions), project data 242 (e.g., project achievements), and other suitable data.

Next, a general description of the operation of the various components of the networked environment 200 is provided. To begin, a user can start a job with a company and the company can create a user profile for the user in the company data store 225. A client device 206 for the user can display a profile user interface 120. The user can enter profile data 233 and skills data 236 in the profile user interface 120. At this stage, the entered data represents profile information and skill information. This initial set of data can represent the user's skill set and status at the beginning of the user's employment with the company. Additionally, the user can also enter project data 242 into the profile user interface 120 associated with the initial projects assigned to the user.

During the course of the initial projects or after the completion of the projects, the verification service 221 can identify other users that were assigned to the project. The computing environment 203 can send a review user interface 130 to these other users. The other users can enter their reviews of the user and other team members for the project. The reviews can be provided in a structured format (e.g., a rating a particular user on scale between 1-10) and/or an unstructured format (e.g., free form text). The review information can be stored and analyzed as feedback data 239 and/or skills data 236. For example, the structured review information can include a rating from multiple users. The ratings can be stored as feedback data 239 for the user.

The unstructured portion of the review can be analyzed to extract skills that the user employed during the project that should be recorded. For example, a reviewer mentioned that “the user has a very effective software development skills in HTML.” The term “HTML” can be identified in connection with “very effective.” Thus, the computing environment 203 can store in the skills data 236 that the user has HMTL skills and the user's HMTL skills received a positive rating. Accordingly, the user profile 228 of the user is updated over time during the user's tenure at the company. Thus, the user's user profile 228 grows to reflect the current skills set and competency level for each of their skills.

As the user continues to participate in the other projects, the user's user profile 228 can be automatically updated based at least in part on input from various other users and from input from the user as well. With an updated record of the user's skill set and competency in various skills, the verification service 221 can allow managers to make better decisions regarding compensation, promotions, and staffing. For example, another hiring manager can desire to staff a project with multiple members already working at the company. The hiring manager can search the user profiles 228 to identify user profiles 228 of individuals that have the desired skill sets.

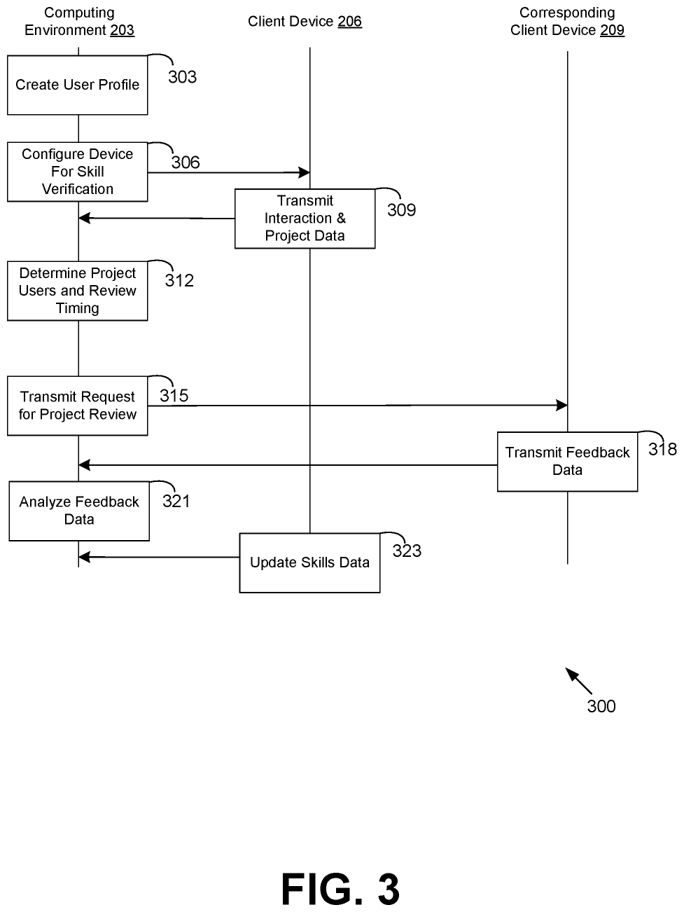

Referring next to FIG. 3, shown is a sequence 300 of operations performed in the networked environment 200. It is understood that the sequence diagram of FIG. 3 provides merely an example of the many different types of interactions that can occur between the depicted components of the networked environment 200. As an alternative, the sequence diagram of FIG. 3 may be viewed as depicting an example of elements of a method implemented in the networked environment 200 (FIG. 2) according to one or more embodiments.

In box 303, the verification service 221 of the computing environment 203 can create a user profile 228 for a user. The verification service 221 can assign the user profile 228 a user identifier 230.

In box 306, the verification service 221 can configure the client device 206 for skills verification. The verification service 221 can transmit data to the client application 251. The transmitted data can instruct the client application 251 to record interaction data 240 and skills data 236. For example, the client application 251 can be instructed to record or identify particular types of interaction data 240, such as project related email, project users, project start dates, project end dates, project calendar meetings, chat messages among project users, and other suitable data. Additionally, the client application 251 can be instructed to record or identify particular types of skills data 236, such as training or education courses completed, conference events, and other suitable skills related data.

In some embodiments, the verification service 221 can generate a unique device signature that is unique for the client device 206 of the user. For example, the verification service 221 can store a device signature for the client device that includes one or more of an IP address for the client device, a geographic location of the client device 206, a device type, a set of installed applications, and other suitable data.

In box 309, the client application 251 can identify the interaction data 240 (e.g., interaction events) over a period of time. Interaction events can be identified in the background while the user is working on one or more projects. Additionally, the client device 206 can transmit project data 242. In some examples, the project data 242 is specified by the user, in which the client device 206 displays a profile user interface 120 for the user to enter project data. In other instances, the client application 251 can identify project data 242 in the background. The client application 251 can periodically transmit the interaction data 240 and the project data 242 to the verification service 221.

In box 312, the verification service 221 can determine project users for the projects. The project users (e.g., peers, managers, subordinates) can be identified in various ways. For example, the verification service 221 and/or the client application 251 can identify the project users from interaction data 240 (e.g., email data, chat messaging data, calendar meetings data, etc.). In other instances, the project users can be explicitly identified by the user and/or other project users from a review user interface 130.

Additionally, the verification service 221 can determine when to solicit feedback data 239, such as in response to a project event (e.g., project milestone, project completion), on a period interval, at random time periods, or at other suitable instances. For example, project characteristics 245 can indicate that a particular project is anticipated to have a project length of two years. The verification service 221 can determine different points in time for soliciting review for project users, such as every six months for the two-year period. In another example, the verification service 221 can determine to solicit reviews of project users after a completion of a project milestone or the completion of project based at least in part on the expected project length being shorter (e.g., less than seven months). These conditions can be set as a project timing threshold.

In box 315, the verification service 221 can monitor a period of time of the project and/or can monitor for project events. Once a project timing threshold has been met (e.g., project event detected, project periodic interval reached), the verification service 221 can transmit data to the corresponding client devices 206 of project users to prompt a review user interface 130 to be displayed. The project users can enter feedback data 239 into the review user interface 130.

In box 318, the verification service 221 can transmit the feedback data 239. The feedback data 239 can be structured and/or unstructured. For example, structured feedback can include a numerical rating (e.g., a scale between 1 to 10). The unstructured feedback can include a testimonial or a freeform text that is provided by the project user.

In box 321, the verification service 221 can analyze the feedback data 239. In some instances, the feedback data 239 can review the unstructured text to extract skills data 236. For example, the unstructured text of a review may state “Jane is an excellent software developer. She is great with HTML.” The machine learning service 223 can use a sentiment analysis of the text to conclude that the review is positive. Additionally, the machine learning service 223 can extract the term “HTML” for storage as skills data 236 and the sentiment analysis can determine the positive sentiment is related to Jane's HTML skills.

In box 323, the client application 251 can provide updated skills data 236 to the verification service 221. For example, the user (e.g., Jane Doe) may want to update new skills data. She can navigate a browser to the profile user interface 120 and enter a new skill that she has developed on a recent project. For instance, she can enter new skills such as Learning Management System, .NET core, TensorFlow, and other suitable data. The verification service 221 can receive the new data as skills data 236 and update the user's user profile 228.

Turning now to FIG. 4A, shown is a search user interface 403 for identifying search criteria for a search query of one or more user profiles 228. In the illustrated embodiment, the user can restrict the search query to include a particular degree major 406a, a particular certification 406b, a geographic location 406c, and search terms 409. After the search criteria has been entered, the verification service 221 can execute a search at the search index database in order to generate a search results user interface (FIG. 4B).

Moving on to FIG. 4B, shown is a search results user interface 415 that is shown on the client device 206. The search results user interface 415 can include a list 418 of one or more user profiles 228 that have been identified from the search query. Continuing with the previous example, the search query had a search term of “HTML.” As such, the list 418 includes multiple user profiles in which each user profile 228 is of a user with “HTML” skills.

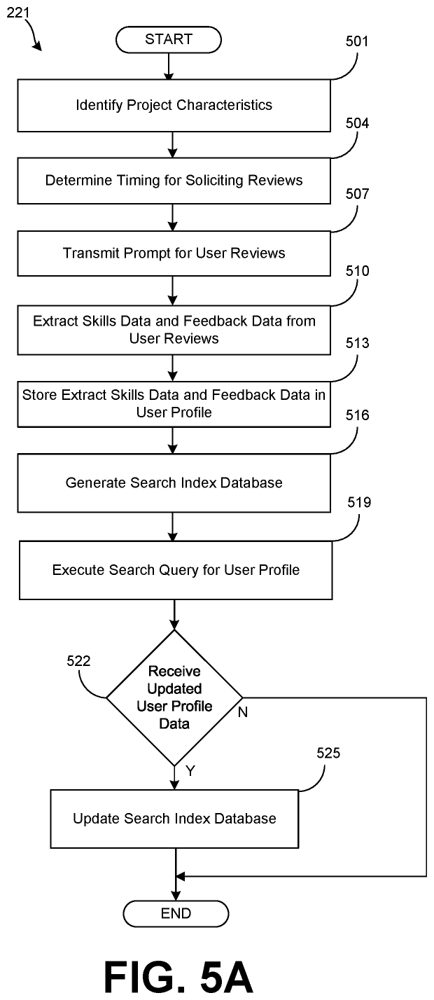

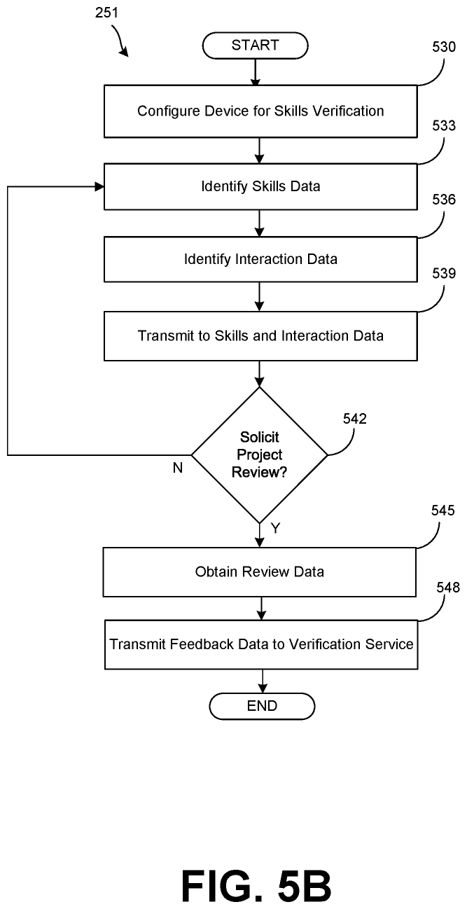

Referring next to FIG. 5A, shown is a flowchart that provides one example of the operation of a portion of the verification service 221 according to various embodiments. It is understood that the flowchart of FIG. 5A provides merely an example of the many different types of functional arrangements that may be employed to implement the operation of the portion of the verification service 221 as described herein. As an alternative, the flowchart of FIG. 5A may be viewed as depicting an example of elements of a method implemented in the computing environment 203 (FIG. 2) according to one or more embodiments.

Beginning with box 501, the verification service 221 can create a user profile 228 for a user, such as an employee of a company. In some examples, the user profile 228 can be created when the user starts their employment with the company. The verification service 221 can retrieve profile data 233 from a human resource file or other source of data.

The verification service 221 can identify characteristics 245 associated with one or more projects assigned to the user. In some instances, the characteristics 245 are received from data provided by the user via the profile user interface 120 and/or review user interface 130. In other instances, the characteristics 245 can be identified based at least in part on interaction data 240 observed on the client device 206 of the user and the corresponding client devices 206 of the project users. For example, the verification service 221 can receive interaction data 240 related to emails, chat messages, calendar meetings, and other suitable data from the client device 206 and the corresponding client device 206 of the project users. The interaction data 240 can be parsed to identify project titles, a project start date, a project end date, project users participating in the project, project hierarchy (e.g., critical project or urgent project), and other suitable interaction data.

In box 504, the verification service 221 can determine the timing or conditions for soliciting project reviews (e.g., feedback data 239 or skills data 236). Based at least in part on the characteristics 245, the verification services 221 can determine whether reviews should be transmitted in response to project events (e.g., project milestones, project completion achieved, etc.), on a periodic interval (e.g., every six months), randomly, or at other suitable occasions. For example, if the project length is anticipated to be around six months, the verification service 221 can select to send reviews to project users at the completion of the project.

In box 507, the verification service 221 can prompt for user reviews to one or more project users for certain projects for a user based at least in part on conditions being met. For example, the verification service 221 can transmit a review prompt (see e.g., FIG. 1C review user interface 130) to a project leader (e.g., Julia Wills). The project leader can display a review user interface 130 for all of her subordinates, in which Jane Doe is one of her subordinates for this project. The verification service 221 can determine the timing of this review based at least in part on the project completing a first stage.

In another example, the verification service 221 can transmit a prompt to Jane Doe to provide review information for her peers. The timing of the review can be selected based at least in part on a random timing, a threshold of interaction data 240 being collected, or other suitable conditions.

In box 510, the verification service 221 can analyze the review information in order to extract skills data 236 and feedback data 239. For example, unstructured feedback can include a testimonial review written in free form. The review can be analyzed by the machine learning service 223 to perform a sentiment analysis. The sentiment analysis can be executed to determine a structured rating (e.g., numerical rating, positive/neutral/negative classification, etc.). The structure rating can be considered as feedback data 239.

Additionally, the verification service 221 can use a machine learning service 223 to extract key terms related to skills associated with the user. For example, a project user may provide a review that states “Jane is an excellent software developer. She is very familiar with CSS, JS, and iOS.” From the unstructured review, the verification services 221 can identify software development platforms “CSS, JS, and iOS” as skills the user employed during the course of the project. The verification service 221 can also associate these skills with the phrase “excellent software developer” and “very familiar.” As such, the user will receive positive ratings for each of these skills based at least in part on the testimonial.

In box 513, the verification service 221 can store the data in each user's user profile 228. For example, the structured feedback can be stored in the user profile 228. Additionally, the structured feedback can be used to generate derived data, such as an average score, a median score, and other suitable statistics. In some embodiments, the sentiment analysis can provide probability statistics for different classifications, such as a first probability of a positive review, a second probability of negative review, a third probability of a neutral review, and other suitable probabilities.

In box 516, the verification service 221 can generate a search index database that can be used to identify user profiles 228 in response to a search query. The search index database (e.g., data store 225) can index user profiles 228 with respect to the relevant search terms, such as terms found in the skills data 236, profile data 233, the feedback data 239, and other suitable data.

In box 519, the verification service 221 can execute a search query for a user profile. For example, a project manager can desire to staff a project with various members. The project manager can use the search index database to identify potential users for joining the project. For instance, the project manager may enter criteria such as an iOS developer and speaks English and Portuguese. After these search criteria have been entered, the search index database can provide search results that include a list of user profiles that meet the search criteria.

Further, in box 522, the verification service 221 can determine whether there is updated data associated with the user profile 228 for processing. In some embodiments, if there is no updated data, then the verification service 221 can proceed to box 501, box 507, or wait until updated data is received. If there is updated data, the verification service 221 can proceed to box 525. For example, the user may have developed a new skill on a project, and the user enters the new skill information in the profile user interface 120. In other examples, the verification service 221 can identify new data from a review provided by a project user. In another example, the verification service 221 can periodically communicate with the remote computing devices 212 for updates on a list of users (e.g., a list of users associated with a company). The remote computing device 212 can respond with updated items that can be constituted as new skills data 236 (e.g., completion of a training course, a university degree, a license, etc.). In other instances, the verification service 221 can crawl various remote computing devices 212. As such, the verification service 221 can be executed to discover new training and education providers with data on a list of user profiles 228 associated with a company. In other instances, the verification service 221 can crawl social media providers to discover content describing one or more users with user profiles 228 for the company.

In box 525, the verification service 221 can update the search index database by storing in the updated data in associated with each user profile 228. For example, new skills can be identified for Jane Doe in response to a query to an online training course. The online training course can indicate that Jane Doe completed a first course for recurrent neutral network and a second course in learning Mandarin. The online training course provider can provide the user identifier 230 for Jane Doe and data related to the completion of two courses. The verification service 221 can user profiles 228 to include these two courses in skills data 236. Then, the verification service 221 proceeds to the end.

Referring next to FIG. 5B, shown is a flowchart that provides one example of the operation of a portion of the client application 251 according to various embodiments. It is understood that the flowchart of FIG. 5B provides merely an example of the many different types of functional arrangements that may be employed to implement the operation of the portion of the client application 251 as described herein. As an alternative, the flowchart of FIG. 5B may be viewed as depicting an example of elements of a method implemented in the computing environment 203 (FIG. 2) according to one or more embodiments.

Beginning with box 530, the client application 251 can configure the client device 206 for skills verification by communicating with the verification service 221. In some embodiments, the verification service 221 can transmit data to the client device 206 such that the verification service 221 manage the operations of the client device 206 in coordination with the client application 251. In some embodiments, the client application 251 can be a management agent for manage the operations of the client device 206. The transmitted data received from the verification service 221 can be a set of instructions that managing the client device 206. The client application 251 can enforce the set of instructions on hardware components, operating system components, application components, and other suitable aspects of the client device 206. For example, as an management agent, the client application 251 can modify one or more settings for an application executed on the client device 206. The application can be modified in order for the application to report interaction data 240 to the client application 251 and/or the computing environment 203. Thus, the verification service 221 can use the data (e.g., the management instructions) to enforce application settings, operating system settings, hardware settings and other suitable settings on the client device 206. For example, the verification service 221 can transmit instructions for that modify productivity applications (e.g., Internet browser, chat message applications, calendar applications, word processing applications, presentation applications, etc.) for identifying skills data 236 and/or interaction data 240.

As another example, a chat message application can be modified to identify and report data associated with the keywords being discussed in chat conversations. From the chat conversations, the chat message application can report to project users that a particular user is in conversations regarding particular keywords.

In box 533, the client application 251 can identify skills data 236 on the client device 206. In some embodiments, the client application 251 can identify skills-orientated applications. For instance, the client application 251 can identify a type of application that is associated with a certain skill, such as the client device 206 executing a particular development platform.

In box 536, the client application 251 can identify interaction data 240 being generated by the client device 206. For example, the email data, calendar meetings, office productivity documents, and other suitable data can be identified. These interaction data 240 can be used to identify project characteristics 245, such as project users (e.g., peers, managers, subordinates, etc.), product descriptions, project hierarchy, and other suitable project characteristics 245.

In box 539, the client application 251 can transmit the skills data 236 and the interaction data 240 to the verification services 221. The skills data 236 and the interaction data 240 can be transmitted based at least in part on various timing conditions, such as a periodic interval, in response to a threshold condition, on demand, and other suitable conditions.

In box 542, the client application 251 can determine whether to review conditions that have been for soliciting a review of project users. If the conditions have not been met, then the client application 251 can proceed to box 533. If the conditions have been met, then the client application 251 can proceed to box 545.

In box 545, the client application 251 can obtain review data from a project review interface. The review data can include structured data or unstructured data associated with a particular project user. In some embodiments, the client application 251 can display a profile user interface 120 based at least in part on the conditions being met. In other examples, the client application 251 can receive an indication from the verifications service 221 to prompt the user for a review. In this example, the functionality associated with box 542 can be omitted.

In box 548, the client application 251 can transmit the review data to the verification services 221. In some embodiments, the client application 251 can transmit the review data for storage in the user profile 228, in which the review data can be analyzed for skills data 236 and feedback data 239.

A number of software components are stored in the memory and are executable by the processor. In this respect, the term “executable” means a program file that is in a form that can ultimately be run by the processor. Examples of executable programs may be, for example, a compiled program that can be translated into machine code in a format that can be loaded into a random access portion of the memory and run by the processor, source code that may be expressed in proper format such as object code that is capable of being loaded into a random access portion of the memory and executed by the processor, or source code that may be interpreted by another executable program to generate instructions in a random access portion of the memory to be executed by the processor, etc. An executable program may be stored in any portion or component of the memory including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory is defined herein as including both volatile and nonvolatile memory and data storage components. Volatile components are those that do not retain data values upon loss of power. Nonvolatile components are those that retain data upon a loss of power. Thus, the memory may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor may represent multiple processors and/or multiple processor cores and the memory may represent multiple memories that operate in parallel processing circuits, respectively. In such a case, the local interface may be an appropriate network that facilitates communication between any two of the multiple processors, between any processor and any of the memories, or between any two of the memories, etc. The local interface may comprise additional systems designed to coordinate this communication, including, for example, performing load balancing. The processor may be of electrical or of some other available construction.

Although the applications described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagram and flowcharts of FIGS. 3, 5A, and 5B show the functionality and operation of an implementation of portions of various embodiments of the present disclosure. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the sequence diagram and flowcharts of FIGS. 3, 5A, and 5B show a specific order of execution, it is understood that the order of execution may differ from that which is depicted. For example, the order of execution of two or more blocks may be scrambled relative to the order shown. Also, two or more blocks shown in succession in FIGS. 3, 5A, and 5B may be executed concurrently or with partial concurrence. Further, in some embodiments, one or more of the blocks shown in FIGS. 3, 5A, and 5B may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that comprises software or code can be embodied in any non-transitory computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device, or in multiple computing devices in the same computing environment 203. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X; Y; Z; X and/or Y; X and/or Z; Y and/or Z; X, Y, and/or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
identify a plurality of characteristics associated with a project assigned to a user identifier based at least in part on interaction data associated with the user identifier;
determine a time period for soliciting a user review for the user identifier based at least in part on the plurality of characteristics for the project;
transmit a prompt to a corresponding client device associated with a project user assigned to the project based at least in part on the time period and the plurality of characteristics;
extract skills data from a prompt response received from at least one of the corresponding client device, wherein the skills data is extracted using a machine learning algorithm; and
generate a search index database that is configured to identify a respective user profile, the skills data being stored in association with the user identifier in the search index database.

2. The system of claim 1, wherein the machine learning algorithm is a natural language processing algorithm.

3. The system of claim 2, wherein the natural language processing algorithm is executed using a neural network comprising at least one of: a recurrent neural network or a convolutional neural network.

4. The system of claim 1, wherein the plurality of characteristics associated with the project comprises at least one of a respective user identifier for the project user assigned to the project, a project start date, a project end date, a current project status, or a project hierarchy status.

5. The system of claim 4, wherein the project user assigned to the project is identified based at least in part on the interaction data associated with the user identifier.

6. The system of claim 5, wherein the interaction data comprises at least one of email data, calendar meeting data, or chat messaging data.

7. The system of claim 1, wherein the machine-readable instructions, when executed by the processor, cause the computing device to at least:
execute a search query that provides a plurality of user profiles for search results based at least in part on entry of a keyword characteristic.

8. A method, comprising:
identifying, by a computing device, a first user identifier and a second user identifier assigned to a project based at least in part on interaction data associated with the first user identifier;
determining, by the computing device, a time period for soliciting a user review of the first user identifier;
transmitting, by the computing device, a prompt for providing the user review of the first user identifier to a corresponding client device associated with the second user identifier assigned to the project based at least in part on the time period;
extracting, by the computing device, skills data from a prompt response received from the corresponding client device, wherein the skills data is extracted using a machine learning algorithm; and
generating, by the computing device, a search index database that is configured to identify a respective user profile, the skills data being stored in association with the first user identifier in the search index database.

9. The method of claim 8, wherein the machine learning algorithm is a natural language processing algorithm.

10. The method of claim 9, wherein the natural language processing algorithm is executed using a neural network comprising at least one of: a recurrent neural network or a convolutional neural network.

11. The method of claim 8, further comprising:
identifying, by the computing device, a plurality of characteristics associated with the project based at least in part on project entry data received from a client device associated with the first user identifier.

12. The method of claim 8, wherein the interaction data comprises at least one of email data, calendar meeting data, meeting transcript data, video communication platform data, a virtual assistant data and chat messaging data.

13. The method of claim 8, further comprising:
executing, by the computing device, a search query that provides a plurality of user profiles for search results based at least in part on entry of a keyword characteristic.

14. The method of claim 8, further comprising:
identifying, by the computing device, additional skills data associated with the first user identifier; and
updating, by the computing device, the search index database to include the additional skills data in association with the first user identifier.

15. A system, comprising:
a computing device comprising a processor and a memory; and
machine-readable instructions stored in the memory that, when executed by the processor, cause the computing device to at least:
identify a plurality of characteristics associated with a project assigned to a user identifier;
determine a time period for soliciting a user review for the user identifier based at least in part on the plurality of characteristics for the project;
display a user interface prompt on a client device associated with the user identifier based at least in part on the time period and the plurality of characteristics;
extract skills data from a prompt response received from the user interface prompt; and
update a searchable index database by storing the skills data in association with the user identifier, the searchable index database being configured to provide a user profile in a search result based at least in part on a search query.

16. The system of claim 15, wherein the time period for soliciting the user review is further determined based at least in part on a trained machine learning model, the trained machine learning model being based at least in part on a plurality of historical projects with a plurality history characteristics.

17. The system of claim 15, wherein the plurality of characteristics associated with the project comprises at least one of a project user assigned to the project, a project start date, a project end date, a current project status, or a project hierarchy status.

18. The system of claim 15, wherein the machine-readable instructions, when executed by the processor, cause the computing device to at least:
crawl a plurality of remote computing devices for content associated with the user identifier; and
update the searchable index database by storing the content in association with the user identifier.

19. The system of claim 15, wherein identifying the plurality of characteristics associated with the project further comprises:
installing a management agent in the client device, the management agent being configured to modify a setting of an application executed on the client device for reporting interaction data;
receive the interaction data from the client device; and
identifying the plurality of characteristics based at least in part on the interaction data.

20. The system of claim 19, wherein the interaction data comprises at least one of email data, calendar meeting data, or chat messaging data.
